(19) United States
(12) Patent Application Publication
(10) Pub. No.: US 2024/0296331 A1
(43) Pub. Date: Sep. 5, 2024

(54) LEARNING NEURAL NETWORK ARCHITECTURES BY BACKPROPAGATION USING DIFFERENTIABLE MASKS

(71) Applicant: Google LLC, Mountain View, CA (US)

(72) Inventors: David Wilson Romero Guzman, Amstelveen (NL); Neil Zeghidour, Paris (FR)

(21) Appl. No.: 18/437,202

(22) Filed: Feb. 8, 2024

Related U.S. Application Data
(60) Provisional application No. 63/444,214, filed on Feb. 8, 2023.

(51) Int. Cl. G06N 3/084; G06N 3/048

(52) U.S. Cl. CPC G06N 3/084; G06N 3/048

(57) ABSTRACT

Methods, systems, and apparatus, including computer programs encoded on computer storage media, for jointly learning the architecture of a neural network during the training of the neural network. In particular, the architecture of the neural network is learned using differentiable parametric masks.

### CROSS-REFERENCE TO RELATED APPLICATION

This application claims priority to U.S. Provisional Application No. 63/444,214, filed on Feb. 8, 2023. The disclosure of the prior application is considered part of and is incorporated by reference in the disclosure of this application.

### BACKGROUND

This specification relates to processing images using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification generally describes a system that jointly trains a neural network to perform a machine learning task and determines the architecture of the neural network.

Particular embodiments of the subject matter described in this specification can be implemented so as to realize one or more of the following advantages.

This specification describes techniques for jointly learning the weights and the architecture of a neural network. That is, the described techniques jointly learn both the weights and the architecture of the neural network as part of training the neural network. By maintaining data defining the architecture of the neural network as learnable differential masks during training, the system can learn the architecture through backpropagation jointly with training the neural network, resulting in a specialized architecture for the training task that outperforms existing architectures.

Moreover, because the architecture is learned jointly with the training of the neural network, the system does not require computationally expensive neural network architecture search to be performed prior to training the neural network, improving the computational efficiency of the search process.

Additionally, by incorporating loss terms that consider the network complexity or the inference latency, the system can discover performant architectures that respect a predefined compute or latency budget.

In some cases, the system can implement techniques that further improve the computational efficiency of the training process without sacrificing performance of the final trained neural network. For example, one approach to applying masks during training would be to render all of the network parameters of the neural network at each training step and then to “mask out” the network parameters that are not part of the current architecture. However, materializing these network parameters can increase the memory consumption and latency of the training process. Instead, the system can render only values for which the mask is non-zero by using the invertible form of the differential masks, significantly reducing “wasted” computation and memory use during the training.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a diagram of an example training system.

FIG. 1B shows examples of differentiable masks that can be used by the system.

FIG. 2 is a flow diagram of an example process for training the neural network.

FIG. 3 is a flow diagram of another example process for training the neural network.

FIG. 4 shows an example of learning the convolutional kernel of a convolutional layer.

FIG. 5 shows an example of a learnable downsampling layer.

FIG. 6 shows an example of the architecture of the neural network when the depth of the neural network is learned during training.

FIG. 7 shows an example of the architecture of the neural network when the width of the neural network is learned during training.

Like reference numbers and designations in the various drawings indicate like elements.

### DETAILED DESCRIPTION

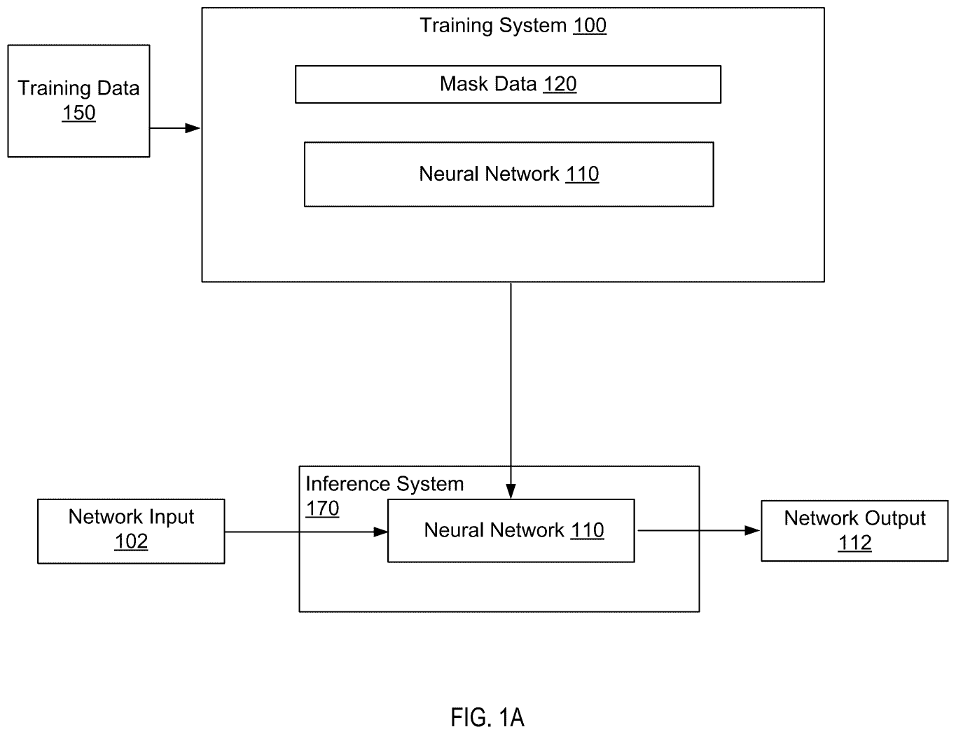

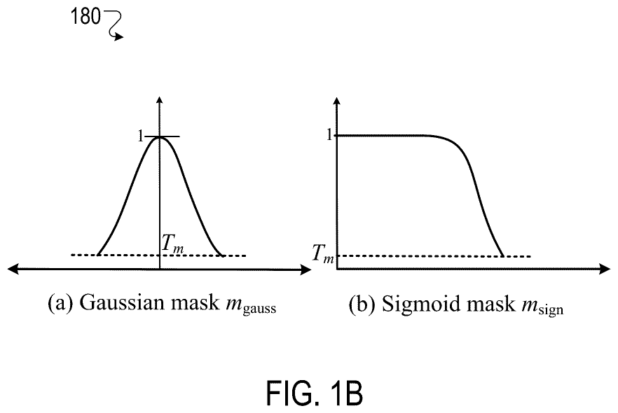

FIG. 1A is a diagram of an example training system 100. The training system 100 is an example of a system implemented as computer programs on one or more computers in one or more locations, in which the systems, components, and techniques described below can be implemented.

The system 100 trains a neural network 110 that is used to perform a machine learning task using training data 150.

The neural network can be trained to perform any kind of machine learning task, i.e., can be configured to receive any kind of digital data input and to generate any kind of score, classification, or regression output based on the input.

In some cases, the neural network is a neural network that is configured to perform an image processing task, i.e., receive an input image and to process the intensity values of the pixels of the input image to generate a network output for the input image. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories. Other examples of image processing tasks include depth prediction, optical flow prediction, and so on.

As another example, if the inputs to the neural network are Internet resources (e.g., web pages), documents, or portions of documents or features extracted from Internet resources, documents, or portions of documents, the task can be to classify the resource or document, i.e., the output generated by the neural network for a given Internet resource, document, or portion of a document may be a score for each of a set of topics, with each score representing an estimated likelihood that the Internet resource, document, or document portion is about the topic.

As another example, if the inputs to the neural network are features of an impression context for a particular advertisement, the output generated by the neural network may be a score that represents an estimated likelihood that the particular advertisement will be clicked on.

As another example, if the inputs to the neural network are features of a personalized recommendation for a user, e.g., features characterizing the context for the recommendation, e.g., features characterizing previous actions taken by the user, the output generated by the neural network may be a score for each of a set of content items, with each score representing an estimated likelihood that the user will respond favorably to being recommended the content item.

As another example, if the input to the neural network is a sequence of text in one language, the output generated by the neural network may be a score for each of a set of pieces of text in another language, with each score representing an estimated likelihood that the piece of text in the other language is a proper translation of the input text into the other language.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, the task may be a keyword spotting task where, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken. As another example, the task can be an audio classification task, e.g., identifying the audio source that generated the video, identifying the speaker in the audio, and so on.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram or other data defining audio of the text being spoken in the natural language.

As another example, the task can be a health prediction task, where the input is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be an agent control task, where the input is an observation characterizing the state of an environment and the output defines an action to be performed by the agent in response to the observation. The agent can be, e.g., a real-world or simulated robot, a control system for an industrial facility, or a control system that controls a different kind of agent.

As another particular example, the task can be a text generation task, where the input is a sequence of text, and the output is another sequence of text, e.g., a completion of the input sequence of text, a response to a question posed in the input sequence, or a sequence of text that is about a topic specified by the first sequence of text. For instance, the neural network can be an autoregressive neural network, e.g., a self-attention based autoregressive neural network. As another example, the input to the text generation task can be an input other than text, e.g., an image, and the output sequence can be text that describes the input.

The training data 150 generally includes a set of training inputs and, for each training input, a respective target output for the machine learning task.

Generally, the neural network 110 has a plurality of neural network layers and is configured to receive a network input 102 and process the network input 102 to generate a network output 112 for the machine learning task.

In particular, during the training of the neural network 110, the system 100 maintains and updates mask data 120 defining, for each of a plurality of hyperparameters of the architecture of the neural network 110, one or more parameters of a parametric differentiable mask over values of the hyperparameter.

The hyperparameters can specify any of a variety of properties of the architecture, e.g., the depth of the architecture, the number of channels in feature representations generated by the architecture, the amount of down-sampling performed by the architecture, the size of convolutional kernels of convolutional layers in the architecture when the network has a convolutional architecture, and so on.

Examples of properties of the architecture that can be specified by the hyperparameters are described in more detail below.

Generally, each parametric differentiable mask maps a subset of the values of the corresponding hyperparameter to non-zero values, e.g., while mapping the remainder of the values of the corresponding hyperparameter to zero values. The subset of the values of the corresponding hyperparameter that are mapped to zero are defined by the parameters of the parametric differentiable mask.

By using the values that are not mapped to zero by the masks for the hyperparameters, the system 100 can determine an architecture of the neural network.

FIG. 1B shows an example 180 of differentiable masks that can be defined by the mask data 120.

Generally, given a function f that maps inputs on an interval [a,b] to real values, a mask can be used to cause the function to be non-zero only in a subset [c,d] of the interval [a,b]. That is, a mask m can be multiplied with the output of f, where the mask maps each value in [c,d] to a value of 1 and each value not in [c,d] to zero.

However, because the gradient of the mask m is either zero or non-defined, it is not possible to learn the interval in which the mask is non-zero by backpropagation. To overcome this limitation, they system instead uses a parametric differentiable mask m(·;θ) whose interval of non-zero values is defined by its parameters θ. As the mask m(·;θ) is differentiable with regard to its parameters θ, the system can learn the interval on which it is non-zero using backpropagation during the training of the neural network 110.

FIG. 1B shows two examples (a) and (b) of differentiable masks that can be employed by the system 100.

As one example, for one or more of the hyperparameters, the parametric differentiable mask over values of the hyperparameter can be a Gaussian mask as shown in example (a). In this example, the one or more parameters of the Gaussian mask include a mean μ of the mask, a parameter defining the variance σ² of the mask, or both.

In particular, the Gaussian mask applied to an input x can be defined as follows:

$${m}_{\text{?}} ( x ; μ , {σ}^{2} ) = \{ \begin{matrix}\overline{m} = exp ( - \frac{1}{2} \frac{{( x - μ )}^{2}}{{σ}^{2}} ) & \overline{m} \geq {T}_{m} \\ 0 & else\end{matrix}$$

$$\text{?} \text{indicates text missing or illegible when filed}$$

As another example, for one or more of the hyperparameters, the parametric differentiable mask over values of hyperparameter can be a Sigmoid mask and the one or more parameters of the Sigmoid mask include an offset μ, a temperature T, or both.

In particular, the Sigmoid mask applied to an input x can be defined as follows:

$${m}_{\text{?}} ( x ; μ , τ ) = \{ \begin{matrix}\overline{m} = 1 - \frac{1}{1 + exp ( - τ ( x - μ ) )} & \overline{m} \geq {T}_{m} \\ 0 & else\end{matrix}$$

$$\text{?} \text{indicates text missing or illegible when filed}$$

In both examples, Tₘ is a predetermined threshold value.

Thus, by changing the parameters θ of a given differentiable mask, the values that are mapped to zero by the mask are also modified.

For example, changing the mean or the variance of the Gaussian mask causes the mask to map different input values to zero.

As another example, changing the offset or temperature of a Sigmoid mask causes the mask to map different input values to zero.

Moreover, because the masks are differentiable functions, the changes to the parameters of the mask can be determined through backpropagation during training of the neural network 110.

In some cases, after training, the differentiable masks are the same for all network inputs 102. In these cases, the system 100 maintains and updates, through backpropagation, the one or more parameters of each of the parametric differentiable masks. That is, in these cases, the system 100 stores, as part of the mask data 120, the one or more parameters of each of the parametric differentiable masks.

In some other cases, after training, the differentiable masks (and therefore the architecture of the neural network 110) are input dependent and can change for different network inputs 102.

In these cases, the system 100 maintains and updates, through backpropagation, additional network parameters of an additional neural network that is configured to receive a network input 102, i.e., the same network input that will be processed by the neural network 110, and to process the network input to generate, for each of a plurality of hyperparameters of the architecture of the neural network, the parameter(s) of each of the parametric differential masks. These parameters are then used to determine the architecture of the neural network 110 when processing the network input.

That is, in these cases, the system 100 stores, as part of the mask data 120, the additional network parameters of the additional neural network instead of directly storing the one or more parameters of each of the parametric differentiable masks. For example, the additional neural network can be a multi-layer perceptron (MLP), a convolutional neural network, or a self-attention neural network.

Once current parameters of the masks are determined (either for a given training input or a set of training inputs) at a given point during the training, the system 100 uses the current parameters to determine a current architecture of the neural network 110 that is defined by the current values of the plurality of hyperparameters and that includes a subset of the network parameters.

That is, the architecture includes the subset of the network parameters that correspond to hyperparameter values that are not set to zero by the corresponding masks. In other words, the system can, for each hyperparameter, use the hyperparameter values that are not set to zero by the corresponding masks to determine a current value of the hyperparameter. The system can then identify, as the subset of the network parameters, the network parameters that are included in the architecture defined by the current values of the hyperparameters.

In some implementations, rather than load all of the network parameters and then use the differentiable masks to “mask out” the network parameters that are not in the current subset, the system can use the invertible form of the differentiable masks to only materialize the subset network parameters and not any network parameter not in the subset, thereby avoiding wasted memory accesses, processor cycles, and other operations required to materialize values from memory and improving the computational efficiency of the process.

In particular, the system can, for each mask, find the hyperparameter value x_{T}_{ₘ} for which the mask is equal to the value Tₘ and only materialize the mask and the corresponding network parameters for hyperparameter values x for which the value of the mask is greater than Tₘ.

For a Gaussian mask, the system can determine the values ±x_{T}_{ₘ} as follows:

$$\pm {x}_{{T}_{m}} = μ \pm \sqrt{- 2 {σ}^{2} log ( {T}_{m} )} .$$

For a Sigmoid mask, the system can determine the system can determine the value x_{T}_{ₘ} as follows:

$${x}_{{T}_{m}} = μ - \frac{1}{T} log ( \frac{1}{1 - {T}_{m}} - 1 ) .$$

Consequently, the system can make sure that all rendered or materialized values will be used by only materializing the mask and related network parameters for hyperparameter values x within the range [−x_{T}_{ₘ}, x_{T}_{ₘ}] for Gaussian masks and [xₘᵢₙ, x_{T}_{ₘ}] for Sigmoid masks, where xₘᵢₙ depicts the lowest coordinate indexing the mask.

The system 100 can then update, by backpropagating gradients of a loss function for the training, both the current parameters of the masks (either directly or by updating the additional network parameters) and the network parameters that are included in the current architecture. To that end, the system 100 can insert, in the architecture of the neural network, values that are dependent on the non-zero values in each of the masks. For example, the system can modify current values of the network parameters based on the non-zero values, modify intermediate outputs of one or more of the layers based on the non-zero values, or both. Examples of doing this are described below.

Generally, the loss function for the training includes one or more terms that measure the quality of the training outputs generated by the neural network 110. These terms will be referred to as “task loss terms” and can generally include any appropriate losses for the machine learning task. Examples of such losses can include cross-entropy losses, log likelihood losses, mean squared error losses, and so on.

In some implementations, the loss function for the training can also include additional terms that constrain the amount of computational resources consumed by the neural network 110 when processing a given set of one or more inputs.

For example, the loss function can include one or more additional terms that measure a computational complexity of the neural network given the current parameters of the parametric differentiable masks. For example, the system can determine the computational complexity of a given layer based on the sizes of the masks that determine the number of parameters within the given layer and then add a loss term that measures the sum of the computational complexities of the layers in the neural network to the loss function. The size of a mask can be calculated in a differentiable manner by determining the length of the mask in continuous space and using that length to estimate the change in size of the corresponding network dimension.

In some cases, these additional terms can measure the computational complexity of the neural network relative to a target computational complexity for the neural network, e.g., as a ratio or a squared difference between the actual computational complexity (determined as described above) and the target computational complexity.

As another example, the loss function can include one or more additional terms that measure a memory efficiency of the neural network given the current parameters of the parametric differentiable masks.

As another example, the loss function can include one or more additional terms that measure a robustness of the neural network given the current parameters of the parametric differentiable masks.

As another example, the loss function can include one or more additional terms that measure a hardware-awareness of the neural network given the current parameters of the parametric differentiable masks when deployed on a particular set of one or more hardware devices, e.g., on a set of one or more hardware accelerators that are optimized for performing machine learning inference. Examples of such accelerators include GPUs, TPUs, and other ASICs that perform matrix multiplications in hardware. Generally, each of these terms can measure a certain aspect of the performance of the neural network when deployed on the particular set of hardware devices. Examples of such aspects include latency, memory consumption, operational intensity, and so on.

By including one or more of these additional terms in the loss function, the system 100 can update the differentiable masks during training in order to cause the architecture of the neural network to have specific properties that are governed by the additional loss function terms.

After training, the system 100 or another inference system 170 can use the neural network 110 (and, in some cases, the additional neural network) to generate predicted outputs 112 for the machine learning task for new network input 102.

When the architecture is fixed after training, the system 100 can determine a final architecture of the neural network 110 after the training has completed and then system 100 or the system 170 can process network inputs 112 using a neural network that has the final architecture.

When the architecture is not fixed after training, after the training, the system 100 or the system 170 can receive a new network input 102 and process the new network input 102 using the additional neural network and in accordance with the trained values of the additional network parameters that were determined during the training of the neural network 110 to generate, for each of the plurality of hyperparameters, new parameters of the parametric differentiable mask over values of the hyperparameter. The system can then determine a new architecture of the neural network 110 that is defined by new values of the plurality of hyperparameters determined using the new parameters of the parametric differentiable masks and process the new input 102 to the neural network 110 using an instance of the neural network having the new architecture and in accordance with trained values of the network parameters that are included in the new architecture and that were determined by training the neural network 110.

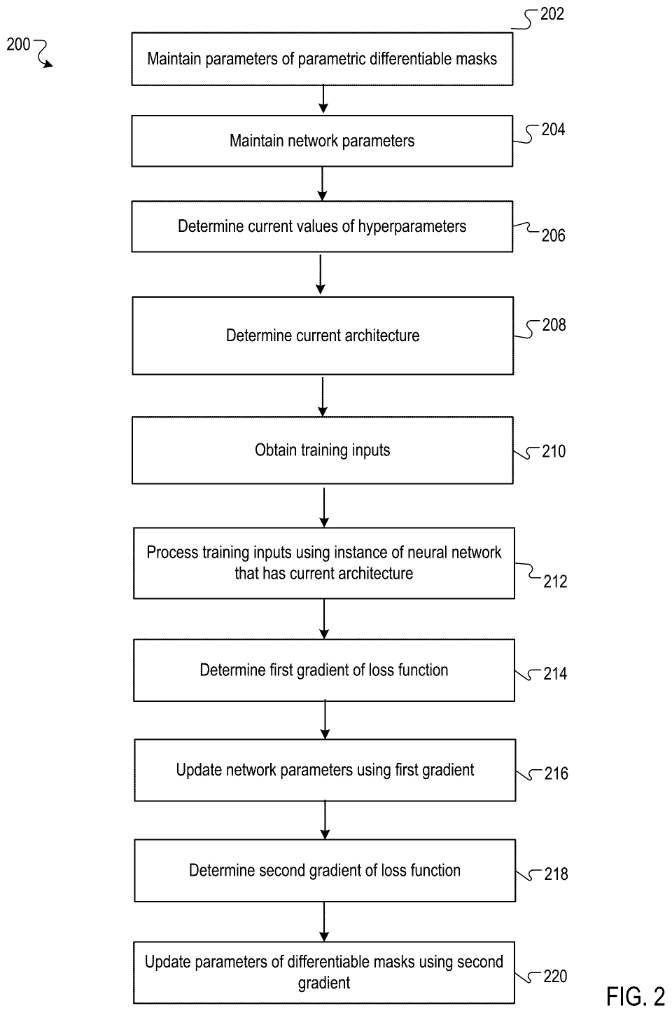

FIG. 2 is a flow diagram of an example process 200 for jointly training a neural network and determining the architecture of the neural network. For convenience, the process 200 will be described as being performed by a system of one or more computers located in one or more locations. For example, a training system, e.g., the training system 100 depicted in FIG. 1A, appropriately programmed in accordance with this specification, can perform the process 200.

In particular, in the example of FIG. 2, after training is completed, the architecture is the same for each new network input that is received for processing by the neural network.

The system maintains, for each of a plurality of hyperparameters of the architecture of the neural network, one or more parameters of a parametric differentiable mask over values of the hyperparameter (step 202).

As described above, each parametric differentiable mask maps a subset of the values of the corresponding hyperparameter to non-zero values, with the subset of the values that are mapped to non-zero values being defined by the parameters of the parametric differentiable mask.

Th system maintains network parameters of the neural network (step 204), e.g., the weights and, optionally, biases of the layers of the neural network. As will be described below, for any convolutional layers in the network. the network parameters can instead or in addition include parameters of a continuous convolutional kernel neural network for the convolutional layer.

The system can initialize the network parameters and the mask parameters using any appropriate initialization scheme, e.g., a random initialization technique.

The system then performs steps 206-220 at each of multiple training iterations in order to train the neural network and to determine the architecture of the neural network. For example, the system can continue to perform iterations of steps 206-220 until a termination criterion is satisfied, e.g., the network parameters have converged, a threshold number of iterations have been performed, a threshold amount of time has elapsed, and so on.

The system determines, for each of the plurality of hyperparameters, a current value of the hyperparameter according to the parameters of the parametric differentiable mask over the values of the hyperparameter (step 206).

That is, for each hyperparameter, the system determines a current value of the hyperparameter by determining the values that the parametric differentiable mask maps to non-zero values.

The system determines a current architecture of the neural network that is defined by the current values of the plurality of hyperparameters and that includes a subset of the network parameters (step 208).

In some cases, the system can leverage the invertible forms of the differentiable masks to materialize only the network parameters that are in the subset, rather than the entire set of network parameters, as described above.

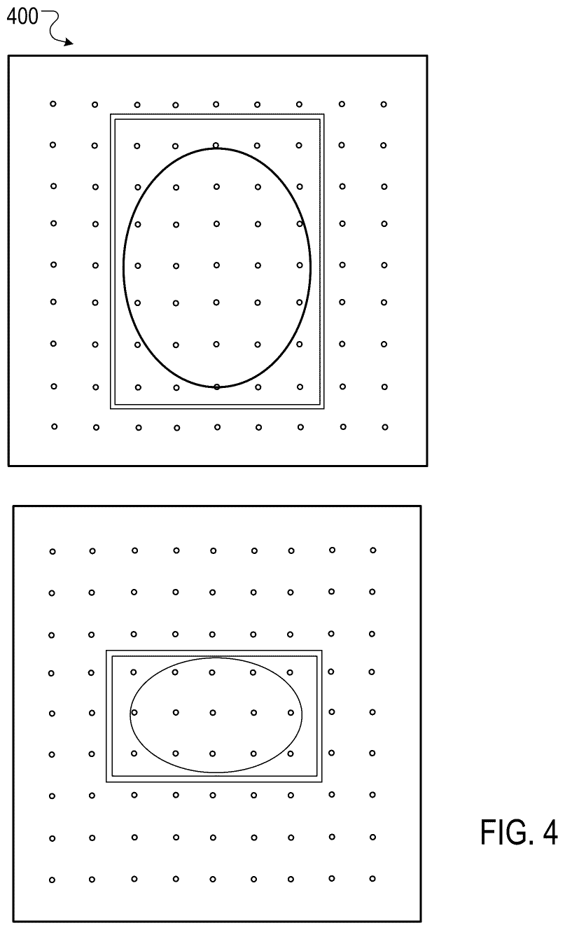

Examples of hyperparameters and how those hyperparameters impact the architecture of the neural network are provided below with reference to FIGS. 4-7.

The system obtains a set of training inputs for the training iterations (step 210), e.g., by sampling the set of training inputs from a larger set of training data.

The system processes each of the training inputs using an instance of the neural network having the current architecture defined by the current values of the plurality of hyperparameters to generate a respective training output for each of the inputs (step 212).

The system determines, through backpropagation, a first gradient with respect to the subset of the network parameters that are included in the current architecture of a loss function that includes one or more terms that measure a quality of the training inputs (step 214).

The system updates, using the first gradient, the network parameters that are included in the current architecture (step 216). For example, the system can apply an optimizer, e.g., Adam, AdamW, Adafactor, SGD, and so on, to the first gradient to update the network parameters.

The system determines, through backpropagation, a second gradient with respect to the parameters of the parametric differentiable masks for the plurality of hyperparameters of the loss function (step 218). That is, because the masks are differentiable, the system can backpropagate through the application of the differentiable masks within the architecture in order to compute the gradient of the loss function with respect to the parameter(s) of each of the masks.

The system updates, using the second gradient, the parameters of the parametric differentiable masks for the plurality of hyperparameters of the loss function (step 220). For example, the system can apply an optimizer, e.g., Adam, AdamW, Adafactor, SGD, and so on, to the second gradient to update the mask parameters.

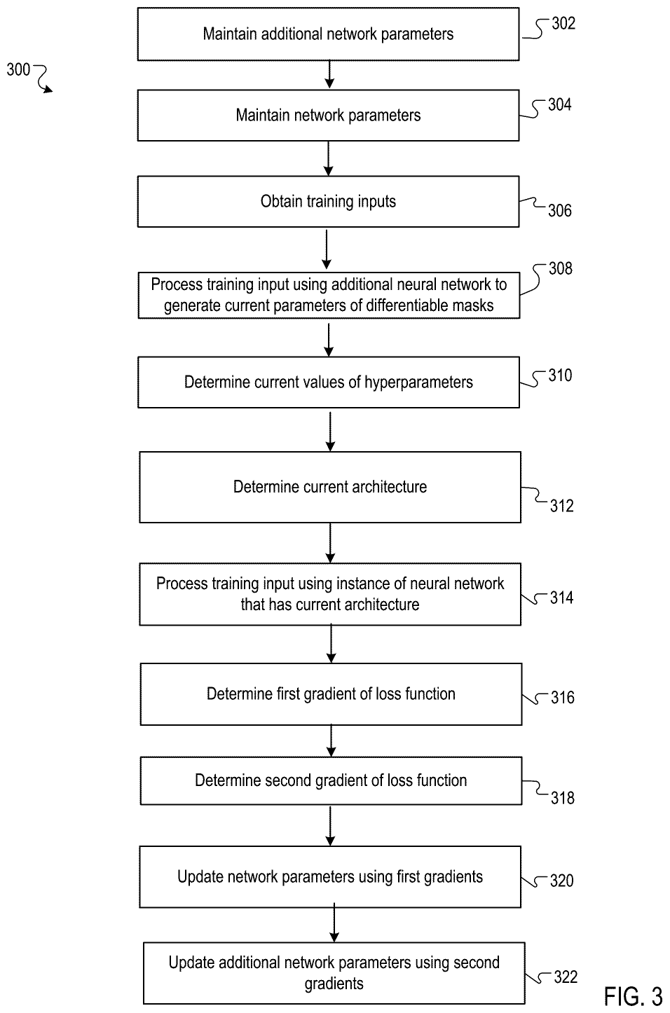

FIG. 3 is a flow diagram of another example process 300 for jointly training a neural network and determining the architecture of the neural network. For convenience, the process 300 will be described as being performed by a system of one or more computers located in one or more locations. For example, a training system, e.g., the training system 100 depicted in FIG. 1A, appropriately programmed in accordance with this specification, can perform the process 300.

In particular, in the example of FIG. 3, after training is completed, the architecture of the neural network can be different for different network inputs that are received for processing by the neural network.

The system maintains additional network parameters of an additional neural network that is configured to receive a network input and to process the network input to generate, for each of a plurality of hyperparameters of the architecture of the neural network, one or more parameters of a parametric differentiable mask over values of the hyperparameter (step 302).

As described above, each parametric differentiable mask maps a subset of the values of the corresponding hyperparameter to non-zero values and the subset of the values is defined by the parameters of the parametric differentiable mask. Thus, rather than directly maintain the parameters of the masks, the system instead maintains parameters of a neural network that outputs the parameters of the masks conditioned on a network input.

The system maintains network parameters of the neural network (step 304). As will be described below, for any convolutional layers in the network. the network parameters can instead or in addition include parameters of a continuous convolutional kernel neural network for the convolutional layer.

The system can initialize the network parameters and the additional network parameters using any appropriate initialization scheme, e.g., a random initialization technique.

The system then performs steps 306-322 at each of multiple training iterations in order to train the neural network and to determine the architecture of the neural network. For example, the system can continue to perform iterations of the steps until a termination criterion is satisfied, e.g., the network parameters have converged, a threshold number of iterations have been performed, a threshold amount of time has elapsed, and so on.

The system obtains a set of training inputs for the training iteration (step 306).

The system then preforms steps 308-316 for each of the training inputs.

The system processes, using the additional neural network and in accordance with the additional network parameters, the training input to generate, for each of the plurality of hyperparameters, current parameters of the parametric differentiable mask over values of the hyperparameter (step 308).

The system determines, for each of the plurality of hyperparameters, a current value of the hyperparameter according to the current parameters of the parametric differentiable mask over the values of the hyperparameter (step 310).

The system determines a current architecture of the neural network that is defined by the current values of the plurality of hyperparameters and that includes a subset of the network parameters (step 312).

The system processes the training input using an instance of the neural network having the current architecture defined by the current values of the plurality of hyperparameters to generate a training output for the training input (step 314).

The system determines, through backpropagation, a first gradient with respect to the subset of the network parameters that are included in the current architecture of a loss function that comprises one or more terms that measure a quality of the training inputs (step 316).

The system determines, through backpropagation, a second gradient with respect to the additional network parameters of the loss function (step 318). That is, because the masks are differentiable, the system can backpropagate through the application of the differentiable masks within the architecture and into the additional neural network in order to compute the gradient with respect to the additional network parameters.

The system updates, using the first gradients for the training inputs, the network parameters that are included in the current architecture (step 320). For example, the system can apply an optimizer, e.g., Adam, AdamW, Adafactor, SGD, and so on, to the first gradient to update the network parameters.

The system updates, using the second gradients for the training inputs, the additional network parameters (step 322). For example, the system can apply an optimizer, e.g., Adam, AdamW, Adafactor, SGD, and so on, to the second gradient to update the additional network parameters.

As described above, in any of the above implementations, the system can learn any of a variety of properties of the architecture of the neural network jointly with the training of the neural network.

In particular, in some implementations, the neural network is a convolutional neural network, i.e., a neural network that includes one or more convolutional neural network layers.

In these implementations, the hyperparameters can include, for each of the one or more convolutional network layers, one or more hyperparameters that define a size of the convolutional kernel of the convolutional neural network layer and that each correspond to a respective dimension of the convolutional kernel.

FIG. 4 shows an example 400 of learning the convolutional kernel of a convolutional layer.

In particular, in the example 400, the convolutional kernel is a two-dimensional kernel and the plurality of hyperparameters include a first hyperparameter corresponding to a height of the convolutional kernel and a second hyperparameter corresponding to a width of the convolutional kernel.

Thus, the kernel includes each (x,y) coordinate for which: the mask for the first hyperparameter maps y to a non-zero value and the mask for the second hyperparameter maps x to a non-zero value. Therefore, as shown in the example 400, (x,y) coordinates for which either the mask for the first hyperparameter maps y to a zero value or the mask for the second hyperparameter maps x to a zero value or both are not included in the convolutional kernel.

In order to instantiate the kernel at any given training step, the system can, for each network parameter that corresponds to a coordinate within the convolutional kernel that is not mapped to zero by the one or more hyperparameters that define the size of the convolutional kernel, determine a current value of the network parameter and then determine the value of the network parameter in the current architecture based on a product of the current value and, for each dimension of the convolutional kernel, an output generated for the component of the coordinate along the dimension by the parametric differentiable mask corresponding to the hyperparameter. This introduces a dependency on the values of the differentiable mask for the computation of the convolutional layer, allowing gradients to be computed with respect to the mask parameters.

In some implementations, rather than directly storing the network parameters of the convolutional kernel, the system makes use of a continuous convolutional kernel neural network to generate the current values of the network parameters. In particular, to determine the current value of any given network parameter within the convolutional kernel, the system can process an input representing the coordinate of the given network parameter within the convolutional kernel using a continuous convolutional kernel neural network to generate, as output, the current value of the network parameter. The system then trains the kernel neural network jointly with the training of the neural network. For example, the kernel neural network can be a multi-layer perceptron (MLP) or other computationally efficient neural network architecture.

While example 400 shows a two-dimensional kernel, in some implementations the convolutional kernel is a one-dimensional kernel and the plurality of hyperparameters include a first hyperparameter corresponding to a length of the convolutional kernel.

In some implementations, the system implements convolutions performed by some or all of the convolutional layers within the neural network as Fourier convolutions. To perform a convolution between a layer input and a convolutional kernel for the convolutional layer in the spatial domain as a Fourier convolution, the system applies a Fourier transform to the layer input and a convolutional kernel to transform the layer input and the kernel into a Fourier domain, multiplies the transformed layer input and the convolutional kernel in Fourier domain to generate a product, and then applies an inverse Fourier transform to the product to transform the product to the spatial domain.

Generally, performing convolutions as Fourier convolutions can reduce the computational complexity of the convolution operation. As above, the size of the convolutional kernel for the convolutional layer can be defined by one or more of the hyperparameters.

In some implementations, the neural network includes one or more downsampling layers, and the hyperparameters include, for each downsampling layer, a respective hyperparameter that defines a cutoff frequency for the downsampling performed by the downsampling layer.

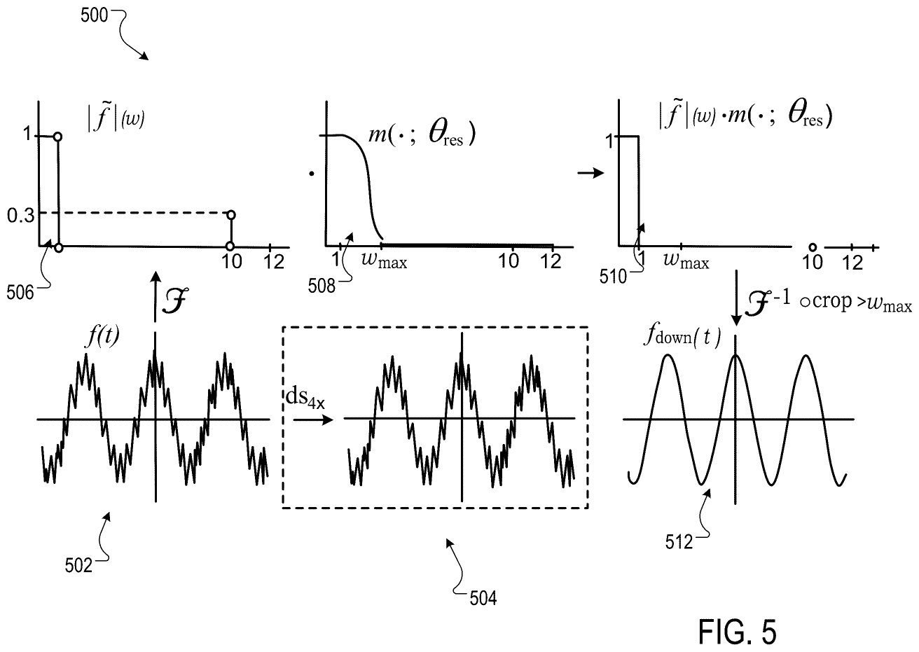

FIG. 5 shows an example 500 of a learnable downsampling layer. In the example of FIG. 5, to downsample a signal, the system applies 502 a Fourier transform to the signal to transform the signal into the Fourier domain. The system then multiplies the resulting spectrum 506 with a corresponding differentiable mask 508 and crops the low-passed spectrum 510 above the cutoff frequency, and then applies an inverse Fourier Transform to transform the cropped spectrum back in to the spatial domain 512.

This avoid the problem of aliasing, where the final resolution is insufficient to accurately represent the underlying signal (box 504 of example 500).

In some of these implementations, rather than include a downsampling layer as a separate layer within the neural network, the system can use Fourier convolutions to incorporate downsampling within a convolution that is performed by a given convolutional layer. A convolutional layer that incorporates downsampling will be referred to in this specification as a “downsampling convolutional layer.”

To perform the operations of such a layer, the system can apply a Fourier transform to the layer input to the layer and the convolutional kernel of the layer to transform the layer input and the kernel into the Fourier domain.

The system can then multiply the transformed layer input and the convolutional kernel in Fourier domain to generate a product, apply downsampling to the product to generate a downsampled product, and then apply an inverse Fourier transform to the downsampled product to transform the product to the spatial domain.

In particular, because the product is represented in the Fourier domain, the downsampling performed by the layer removes high frequency components from the signal.

In particular, the system can perform the downsampling by applying an operator that crops all values in the product above a cutoff frequency.

In some of these implementations, the cutoff frequency is a learnable component of the architecture of the neural network. In particular, the hyperparameters can include, for each downsampling convolutional layer, a respective hyperparameter that defines the cutoff frequency for the downsampling performed by the convolutional layer.

In some implementations, the system can improve the computational efficiency of the operations performed by the downsampling convolutional layer by inverting the order of the operations performed by the layer in order to avoid computing the product for values that will later be cropped.

In particular, the system can identify a minimum resolution for the convolution based on a cutoff frequency for the downsampling, apply a Fourier transform to the layer input and a convolutional kernel to transform the layer input and the kernel into the Fourier domain, downsample the transformed layer input and the convolutional kernel to the minimum resolution, multiply the downsampled transformed layer input and convolutional kernel in the Fourier domain to generate a product, and then apply an inverse Fourier transform to the product to transform the product to the spatial domain.

Thus, the system performs the downsampling before computing the product, eliminating the computation of the values within the product that are then cropped out by the downsampling.

In some implementations, the neural network includes a sequence of residual blocks, with each residual block including a residual and an identity branch. The residual branch generally includes one or more neural network layers, e.g., one or more convolutional layers and, in some cases, one or more other types of neural network layers. The identity branch does not include any neural network layers and outputs the input to the residual block. In a conventional neural network, the final output of the residual block is then a combination of, e.g., a sum or a concatenation of, the outputs of the residual and identity branches.

In some of these implementations, the plurality of hyperparameters includes a hyperparameter such that each value of the first hyperparameter corresponds to a different subset of the residual blocks in the sequence of residual blocks that do not have their output set to zero. In other words, this hyperparameter governs the effective depth of the neural network.

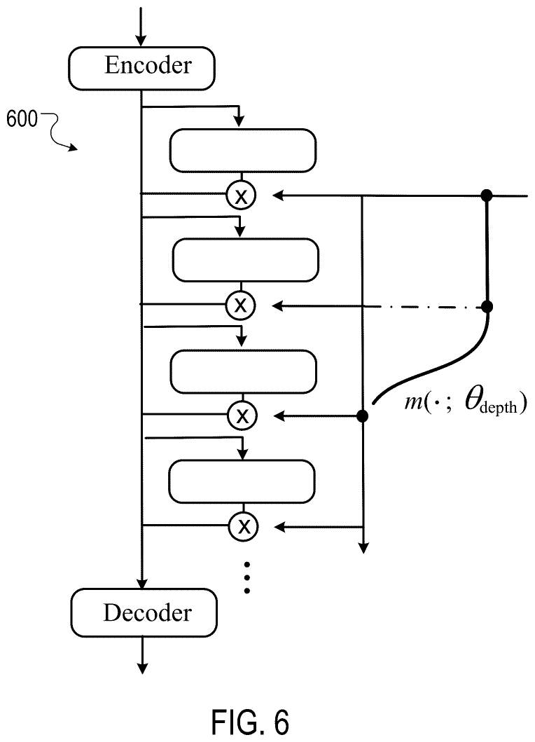

FIG. 6 shows an example 600 of the architecture of the neural network when the depth of the neural network is learned during training.

In the example of FIG. 6, each residual block has a respective index, and, to determine a current architecture of the neural network that is defined by the current values of the plurality of hyperparameters, the system can, for each residual block in the sequence of residual blocks that does not have their output set to zero, can determine a final output of the residual branch of the residual block to be a product of the output of the residual branch and an output generated for the index of the residual block by the parametric differentiable mask corresponding to the dimension. This introduces a dependency on the values of the differentiable mask for the computation of the residual branch, allowing gradients to be computed with respect to the mask parameters.

In some implementations, for each of one or more of the plurality of layers of the neural network, the hyperparameters include (i) an input width hyperparameter having values that specify a number of channels in an input feature representation received as input by the layer, (ii) an output width hyperparameter having values that specify a number of channels in an output feature representation generated as output by the layer; or (iii) both.

In these implementations, the hyperparameters can include, for each of the one or more convolutional network layers, one or more hyperparameters that define a size of the convolutional kernel of the convolutional neural network layer and that each correspond to a respective dimension of the convolutional kernel.

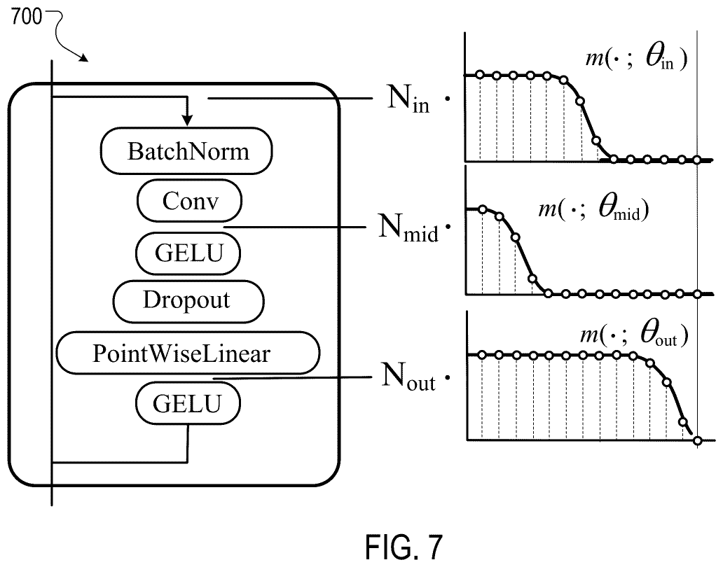

FIG. 7 shows an example 700 of the architecture of the neural network when the width of the neural network is learned during training and the neural network includes residual blocks.

As shown in the example 700, each residual branch of the neural network includes a Batch Normalization (“BatchNorm”) layer, followed by a convolutional layer (“cony”), a GELU non-linear activation function layer, a dropout layer, a pointwise linear (PoinWiseLinear) layer, and another GELU non-linear activation function layer.

In this example, the set of hyperparameters includes three hyperparameters (and, therefore, three differentiable masks) per residual branch: one at the input to the residual branch, one after the convolutional layer within the residual branch, and one at the output of the pointwise linear layer within the residual branch. To generate the outputs of the layers, the initial outputs are multiplied with the mask corresponding to the associated hyperparameter.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers and for jointly (i) determining an architecture of a neural network having a plurality of neural network layers and (ii) training the neural network to perform a machine learning task, the method comprising:
maintaining, for each of a plurality of hyperparameters of the architecture of the neural network, one or more parameters of a parametric differentiable mask over values of the hyperparameter, wherein each parametric differentiable mask maps a subset of the values of the corresponding hyperparameter to non-zero values and wherein the subset of the values is defined by the parameters of the parametric differentiable mask;
maintaining network parameters of the neural network; and
at each of a plurality of training iterations:
determining, for each of the plurality of hyperparameters, a current value of the hyperparameter according to the parameters of the parametric differentiable mask over the values of the hyperparameter;
determining a current architecture of the neural network that is defined by the current values of the plurality of hyperparameters and that includes a subset of the network parameters;
obtaining a set of training inputs for the training iterations;
processing each of the training inputs using an instance of the neural network having the current architecture defined by the current values of the plurality of hyperparameters to generate a respective training output for each of the inputs;
determining, through backpropagation, a first gradient with respect to the subset of the network parameters that are included in the current architecture of a loss function that comprises one or more terms that measure a quality of the training outputs;
updating, using the first gradient, the network parameters that are included in the current architecture;
determining, through backpropagation, a second gradient of the loss function with respect to the parameters of the parametric differentiable masks for the plurality of hyperparameters; and
updating, using the second gradient, the parameters of the parametric differentiable masks for the plurality of hyperparameters of the loss function.

2. The method of claim 1, wherein the loss function includes one or more first additional terms that measure a computational complexity of the neural network given the current parameters of the parametric differentiable masks.

3. The method of claim 2, wherein the one or more first additional terms measure the computational complexity of the neural network relative to a target computational complexity for the neural network.

4. The method of claim 1, wherein the loss function includes one or more second additional terms that measure a memory efficiency of the neural network given the current parameters of the parametric differentiable masks.

5. The method of claim 1, wherein for one or more of the hyperparameters, the parametric differentiable mask over values of the hyperparameter is a Gaussian mask and the one or more parameters of the Gaussian mask include a mean, a parameter defining a variance, or both.

6. The method of claim 1, wherein for one or more of the hyperparameters, the parametric differentiable mask over values of the hyperparameter is a Sigmoid mask and the one or more parameters of the Sigmoid mask include an offset, a temperature, or both.

7. The method of claim 1, wherein the neural network includes one or more convolutional neural network layers, and wherein the plurality of hyperparameters includes, for each of the one or more convolutional network layers, one or more hyperparameters that define a size of a convolutional kernel of the convolutional neural network layer and that each correspond to a respective dimension of the convolutional kernel.

8. The method of claim 7, wherein the convolutional kernel is a two-dimensional kernel and the plurality of hyperparameters include a first hyperparameter corresponding to a height of the convolutional kernel and a second hyperparameter corresponding to a width of the convolutional kernel.

9. The method of claim 7, wherein the convolutional kernel is a one-dimensional kernel and the plurality of hyperparameters include a first hyperparameter corresponding to a length of the convolutional kernel.

10. The method of claim 7, wherein determining a current architecture of the neural network that is defined by the current values of the plurality of hyperparameters and that includes a subset of the network parameters comprises:
for each network parameter that corresponds to a coordinate within the convolutional kernel that is not mapped to zero by the one or more hyperparameters that define the size of the convolutional kernel:
determining a current value of the network parameter; and
determining a value of the network parameter in the current architecture based on a product of the current value and, for each dimension of the convolutional kernel, an output generated for a component of the coordinate along the dimension by the parametric differentiable mask corresponding to the dimension.

11. The method of claim 10, wherein determining the current value of the network parameter comprises processing an input representing the coordinate using a continuous convolutional kernel neural network to generate, as output, the current value of the network parameter, wherein the continuous convolutional kernel neural network is trained jointly with the neural network.

12. The method of claim 11, wherein the neural network comprises a sequence of residual blocks, wherein each residual block includes a residual branch comprising one or more neural network layers and an identity branch.

13. The method of claim 12, wherein the plurality of hyperparameters includes a first hyperparameter and each value of the first hyperparameter corresponds to a different subset of residual blocks in the sequence of residual blocks that do not have their output set to zero.

14. The method of claim 13, wherein each residual block has a respective index, and wherein determining a current architecture of the neural network that is defined by the current values of the plurality of hyperparameters and that includes a subset of the network parameters comprises:
for each residual block in the sequence of residual blocks that does not have their output set to zero:
determining a final output of the residual branch of the residual block to be a product of the output of the residual branch and an output generated for the index of the residual block by the parametric differentiable mask corresponding to the hyperparameter.

15. The method of claim 1, wherein, for each of one or more of the plurality of layers of the neural network, the hyperparameters include:
(i) an input width hyperparameter having values that specify a number of channels in an input feature representation received as input by the layer;
(ii) an output width hyperparameter having values that specify a number of channels in an output feature representation generated as output by the layer; or
(iii) both.

16. The method of claim 1, wherein the neural network includes one or more downsampling layers, and wherein the hyperparameters include, for each downsampling layer, a respective hyperparameter that defines a cutoff frequency for the downsampling.

17. The method of claim 1, wherein:
the neural network includes one or more convolutional neural network layers that perform a convolution between a layer input and a convolutional kernel for the convolutional layer in a spatial domain by:
applying a Fourier transform to the layer input and a convolutional kernel to transform the layer input and the kernel into a Fourier domain,
multiplying the transformed layer input and the convolutional kernel in Fourier domain to generate a product, and
applying an inverse Fourier transform to the product to transform the product to the spatial domain.

18. The method of claim 1, wherein:
the neural network includes one or more downsampling convolutional neural network layers that perform a convolution between a layer input and a convolutional kernel for the downsampling convolutional layer in a spatial domain by:
applying a Fourier transform to the layer input and a convolutional kernel to transform the layer input and the kernel into a Fourier domain,
multiplying the transformed layer input and the convolutional kernel in Fourier domain to generate a product,
applying downsampling to the product to generate a downsampled product, and
applying an inverse Fourier transform to the downsampled product to transform the product to the spatial domain.

19. The method of claim 18, wherein the hyperparameters include, for each downsampling convolutional layer, a respective hyperparameter that defines a cutoff frequency for the downsampling.

20. The method of claim 18, wherein the hyperparameters include one or more hyperparameters that define a size of the convolutional kernel of the downsampling convolutional neural network layer and that each correspond to a respective dimension of the convolutional kernel.

21. The method of claim 1, wherein:
the neural network includes one or more downsampling convolutional neural network layers that perform a convolution between a layer input and a convolutional kernel for the downsampling convolutional layer in a spatial domain by:
identifying a minimum resolution for the convolution based on a cutoff frequency for the downsampling;
applying a Fourier transform to the layer input and a convolutional kernel to transform the layer input and the kernel into a Fourier domain,
downsampling the transformed layer input and the convolutional kernel to the minimum resolution
multiplying the downsampled transformed layer input and convolutional kernel in the Fourier domain to generate a product, and
applying an inverse Fourier transform to the product to transform the product to the spatial domain.

22. The method of claim 21, wherein the hyperparameters include, for each downsampling convolutional layer, a respective hyperparameter that defines the cutoff frequency for the downsampling.

23. The method of claim 21, wherein the hyperparameters include one or more hyperparameters that define a size of the convolutional kernel of the downsampling convolutional neural network layer and that each correspond to a respective dimension of the convolutional kernel.

24. The method of claim 1, further comprising:
after the training, determining a final architecture of the neural network that is defined by final values of the plurality of hyperparameters determined using final parameters of the parametric differentiable masks; and
processing new inputs to the neural network using an instance of the neural network having the final architecture and in accordance with trained values of the network parameters that are included in the final architecture.

25. A method performed by one or more computers and for jointly (i) determining an architecture of a neural network having a plurality of neural network layers and (ii) training the neural network to perform a machine learning task, the method comprising:
maintaining additional network parameters of an additional neural network that is configured to receive a network input and to process the network input to generate, for each of a plurality of hyperparameters of the architecture of the neural network, one or more parameters of a parametric differentiable mask over values of the hyperparameter, wherein each parametric differentiable mask maps a subset of the values of the corresponding hyperparameter to non-zero values and wherein the subset of the values is defined by the parameters of the parametric differentiable mask;
maintaining network parameters of the neural network; and
at each of a plurality of training iterations:
obtaining a set of training inputs for the training iteration;
for each training input in the set:
processing, using the additional neural network and in accordance with the additional network parameters, the training input to generate, for each of the plurality of hyperparameters, current parameters of the parametric differentiable mask over values of the hyperparameter;
determining, for each of the plurality of hyperparameters, a current value of the hyperparameter according to the current parameters of the parametric differentiable mask over the values of the hyperparameter;
determining a current architecture of the neural network that is defined by the current values of the plurality of hyperparameters and that includes a subset of the network parameters;
processing the training input using an instance of the neural network having the current architecture defined by the current values of the plurality of hyperparameters to generate a training output for the training input;
determining, through backpropagation, a first gradient with respect to the subset of the network parameters that are included in the current architecture of a loss function that comprises one or more terms that measure a quality of the training outputs;
determining, through backpropagation, a second gradient with respect to the additional network parameters of the loss function;
updating, using the first gradients for the training inputs, the network parameters that are included in the current architecture; and
updating, using the second gradients for the training inputs, the additional network parameters.

26. The method of claim 25, further comprising
after the training:
receiving a new network input;
processing using the additional neural network and in accordance with trained values of additional network parameters, the new network input to generate, for each of the plurality of hyperparameters, new parameters of the parametric differentiable mask over values of the hyperparameter;
determining a new architecture of the neural network that is defined by new values of the plurality of hyperparameters determined using the new parameters of the parametric differentiable masks; and
processing the new input to the neural network using an instance of the neural network having the new architecture and in accordance with trained values of the network parameters that are included in the new architecture.

27. A system comprising one or more computers and one or more storage devices storing instructions that when executed by one or more computers cause the one or more computers to perform operations for jointly (i) determining an architecture of a neural network having a plurality of neural network layers and (ii) training the neural network to perform a machine learning task, the operations comprising:
maintaining, for each of a plurality of hyperparameters of the architecture of the neural network, one or more parameters of a parametric differentiable mask over values of the hyperparameter, wherein each parametric differentiable mask maps a subset of the values of the corresponding hyperparameter to non-zero values and wherein the subset of the values is defined by the parameters of the parametric differentiable mask;
maintaining network parameters of the neural network; and
at each of a plurality of training iterations:
determining, for each of the plurality of hyperparameters, a current value of the hyperparameter according to the parameters of the parametric differentiable mask over the values of the hyperparameter;
determining a current architecture of the neural network that is defined by the current values of the plurality of hyperparameters and that includes a subset of the network parameters;
obtaining a set of training inputs for the training iterations;
processing each of the training inputs using an instance of the neural network having the current architecture defined by the current values of the plurality of hyperparameters to generate a respective training output for each of the inputs;
determining, through backpropagation, a first gradient with respect to the subset of the network parameters that are included in the current architecture of a loss function that comprises one or more terms that measure a quality of the training outputs;
updating, using the first gradient, the network parameters that are included in the current architecture;
determining, through backpropagation, a second gradient of the loss function with respect to the parameters of the parametric differentiable masks for the plurality of hyperparameters; and
updating, using the second gradient, the parameters of the parametric differentiable masks for the plurality of hyperparameters of the loss function.
